(19) United States
(12) Patent Application Publication
(10) Pub. No.: US 2016/0180298 A1
(43) Pub. Date: Jun. 23, 2016

(54) TASK MAP VISUALIZATION

(71) Applicants: Greg McClement, Maple Ridge (CA); Kai Chan, Burnaby (CA); Wan Gong, Coquitlam (CA); Cesar Hernandez, Vancouver (CA); Ren Horikiri, New Westminster (CA)

(72) Inventors: Greg McClement, Maple Ridge (CA); Kai Chan, Burnaby (CA); Wan Gong, Coquitlam (CA); Cesar Hernandez, Vancouver (CA); Ren Horikiri, New Westminster (CA)

(21) Appl. No.: 14/576,485

(22) Filed: Dec. 19, 2014

(51) Int. Cl. G06Q 10/10; G06F 3/0482; G06F 3/0486; G06F 3/0484

(52) U.S. Cl. CPC G06Q 10/1097; G06F 3/04842; G06F 3/0482; G06F 3/0486; G06F 3/04845

(57) ABSTRACT

A method and system include receiving data associated with one or more tasks; determining an image associated with each of the one or more tasks; presenting each of the images on a display; receiving a selection of one of the images; translating the selected image from a first portion of the display associated with a list of unassigned images associated with tasks to a second portion of the display associated with a timeline. Numerous other aspects are provided.

### BACKGROUND

Task management tools exist to help users manage one or more tasks. For example, electronic calendar and agenda applications may help a user organize his or her appointments or to-do lists. However, due to the nature of some tasks, it may not be easy to organize or keep track of all tasks using a single existing tool. Additionally, existing task management tools may primarily rely on textual entry of task information, which may be time-consuming and cumbersome.

Systems and methods are desired which support easy input and management of tasks.

### BRIEF DESCRIPTION OF THE DRAWINGS

FIG. 1 is a block diagram of a system according to some embodiments.

FIG. 2 is an outward view of a graphical interface according to some embodiments.

FIG. 3 is a flow diagram of a process according to some embodiments.

FIG. 4 is an outward view of a graphical interface according to some embodiments.

FIG. 5 is an outward view of a graphical interface according to some embodiments.

FIG. 6 is an outward view of a graphical interface according to some embodiments.

FIG. 7 is an outward view of a graphical interface according to some embodiments.

FIG. 8 is a text box according to some embodiments.

FIG. 9 is an outward view of a graphical interface according to some embodiments.

FIG. 10 is an outward view of a graphical interface according to some embodiments.

FIG. 11 is a flow diagram of a process according to some embodiments.

FIG. 12 is an outward view of a graphical interface according to some embodiments.

FIG. 13 is an outward view of a graphical interface according to some embodiments.

FIG. 14 is an outward view of a graphical interface according to some embodiments.

FIG. 15 is a text box according to some embodiments.

FIG. 16 is a table according to some embodiments.

FIG. 17 is a block diagram of a system according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

One or more embodiments or elements thereof can be implemented in the form of a computer program product including a computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Task management tools exist to help manage one or more tasks. Tasks may be “time-bound tasks” with a definite timeframe or deadline (e.g., meeting requests with a definite start and end time/date; a deadline) or “non-time bound tasks” that have no set deadline or timeframe (e.g. a shopping or “to do” list).

Some embodiments may include a two-dimensional visual task map that represents individual tasks and groups of tasks as graphical images on a Graphical User Interface (GUI). In some embodiments, tasks may be easily added by allowing the creation of tasks from images (e.g., a list of school supplies), text files, and other documents. For example, task entries may be in the form of a photo, a voice memo or text input. In other words, the data associated with the one or more tasks may be one of a picture, a document, an auditory file or a multimedia file (e.g., a video). The tasks may then be organized and prioritized on a timeline in some embodiments. In one or more embodiments, the tasks may be associated with a location on a geographical map, and the geographical location may be associated with other aspects related to the task.

As used herein, the term “task” refers to an individual task, and the data associated therewith. As used herein, the term “smartphone” refers to any cellular phone that is able to perform many of the functions of a computer, typically having a relatively large screen and an operating system capable of running general- and specific-purpose applications. As used herein, the term “tablet” refers to a general-purpose computer contained in a single panel, typically using a touch screen as the input device capable of running general- and specific-purpose applications. However, other input devices (e.g., keyboard, mouse, etc.) may be coupled to the tablet for use as input devices. Tablets may typically come loaded with a web browser and a variety of applications (“apps”). As used here, the term “app” refers to a self-contained program or piece of software designed to fulfill a particular purpose.

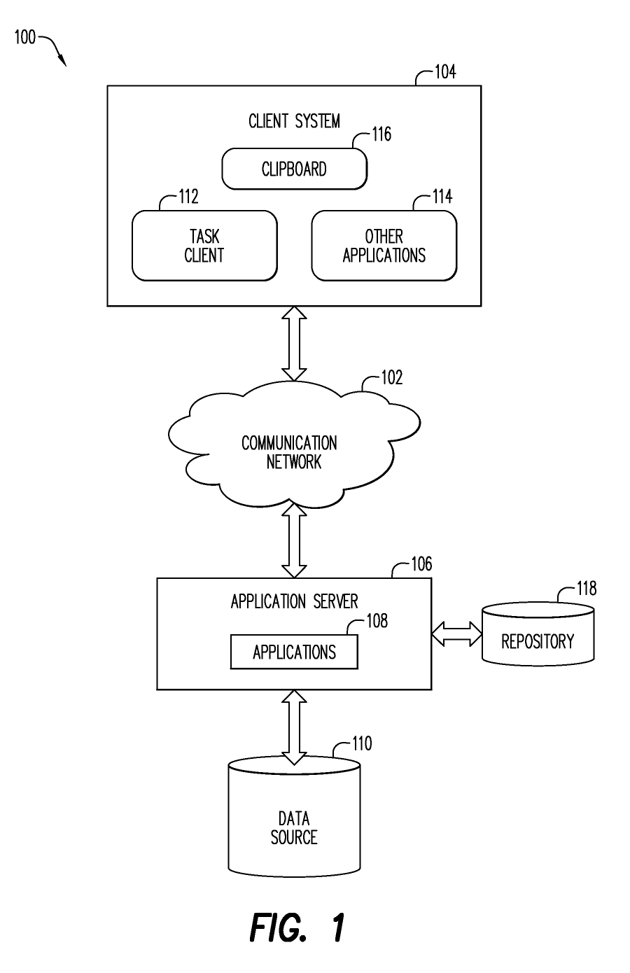

FIG. 1 is a block diagram of an example operating environment 100 in which a task map visualization application may be implemented, arranged in accordance with at least one embodiment described herein. FIG. 1 represents a logical architecture for describing processes according to some embodiments, and actual implementations may include more or different components arranged in other manners.

The operating environment may include a communication network 102, in communication with one or more computing devices (including mobile computing devices—e.g., smartphones, tablets; PCs) 104, which may collectively be referred to herein as “client system”, and one or more servers 106.

In general, the communication network 102 may include any number of different systems for transferring data, including one or more wide area networks (WANs) and/or local area networks (LANs) that enable the client system 104 and the servers 106 to communicate with each other. In some embodiments, the communication network 102 may include the Internet, including a global internetwork formed by logical and physical connections between multiple WANs and/or LANs. Alternately, or additionally, the communication network 102 may include one or more telephone networks, cellular networks, a fiber-optic network, a satellite network, an infrared network, a radio frequency network, any other type of network that may be used to transmit information between devices, and/or one or more wired and/or wireless networks such as, but not limited to Bluetooth access points, wireless access points, IP-based networks, or the like. The communication network 102 may also include servers that enable one type of network to interface with another type of network. Moreover, communication between communication network 102 and each of the depicted devices may proceed over any one or more currently or hereafter-known transmission protocols, such as Asynchronous Transfer Mode (ATM), Internet Protocol (IP), Hypertext Transfer Protocol (HTTP) and Wireless Application Protocol (WAP).

System 100 includes application server 106 to provide data of data source 110 to client system 104. The application server 106 may include at least one Web-accessible storage element for storing and sharing the visual task map application 108 (“task map app”). For example, application server 106 may execute the task map app 108 to receive a request to create a task from a task client 112 (e.g. a photo), to query data source 110 for data required by the task, to receive the data from data source 110, to perform any necessary calculations on the data, to format the task including its data into an image, and to return the imaged task to client system 104.

Application server 106 may provide similar functionality to other (unshown) client systems. Data source 110 and application server 106 may support multi-tenancy to separately support multiple unrelated clients by providing multiple logical database systems which are programmatically isolated from one another.

Data source 110 may comprise any one or more systems that store data that may be a task or related to a task. The data stored in data source 110 may be received from disparate hardware and software systems, some of which are not inter-operational with one another. The systems may comprise a back-end data environment employed in a business, industrial, or personal context. The data may be pushed to data source 110 and/or provided in response to queries received therefrom.

The data may comprise a relational database, a multi-dimensional database, an eXtendable Markup Language (XML) document, and/or any other structured data storage system. The physical tables of data source 110 may be distributed among several relational databases, multi-dimensional databases, and/or other data sources. For example, data source 110 may comprise one or more OnLine Analytical Processing (OLAP) databases (i.e., cubes). The data of data source 110 may be indexed and/or selectively replicated in an index.

Data source 110 may implement an “in-memory” database, in which volatile (e.g., non-disk-based) storage (e.g., Random Access Memory) is used both for cache memory and for storing data during operation, and persistent storage (e.g., one or more fixed disks) is used for offline persistency of data and for maintenance of database snapshots. Alternatively, volatile storage may be used as cache memory for storing recently-used database data, while persistent storage stores data. In some embodiments, the data comprises one or more of conventional tabular data, row-based data stored in row format, column-based data stored in columnar format, and object-based data.

The client system 104 may comprise one or more devices executing program code of a software application for presenting user interfaces to allow interaction with applications 108 of the application server 106. As described above, the client system 104 may comprise a desktop computer, a laptop computer, a personal digital assistant, a tablet PC, and a smartphone, but is not limited thereto.

Task client 112 may comprise program code of a task management application, or any other application to perform the processes attributed thereto herein.

Other applications 114 may comprise one or more of a word processing application, an electronic mail application, a graphics application, a publishing application, and any other application suitable for providing data associated with tasks according to some embodiments. Clipboard 116 may comprise any memory devices and/or locations suitable for storing copied tasks, and for retrieving tasks therefrom for writing to one or more of other applications 114.

Repository 118 stores metadata and data for use by application server 106. The metadata may specify a schema of data source 110, which may be used by application server 106 to query data source 110. The metadata may also define users, data source connections, and member hierarchies.

In some embodiments, the task map app 108 may have various components which may be divided between the client system 104 and the server 106. The various components are collectively referred to hereinafter as the “task map app 108.” Alternatively, the task map app 108 or equivalent functionality thereof may be provided in its entirety on the computing device 104, in which case the server 106 may be omitted.

In one or more embodiments, when the client system 104 is implemented as a mobile device, such as a tablet computer or smartphone, the task map app 108 on the client system 104 may be implemented as an app designed to run/execute on tablet computers, smartphones or other mobile devices. In these and other embodiments, the task map app 108 may communicate through the network 102 with the server 106 to cooperate with and perform one or more of the operations described herein.

Alternatively or additionally, the task map app 108 may be accessed on the client system 104 via a browser (not shown) that communicates through the network 102 with the server 106 to download therefrom. In these embodiments, the task map app 108 is implemented as a runtime script that is executed in the browser in cooperation with the task map app 108 on the server 106 to perform one or more of the operations described herein.

Although system 100 has been described as a distributed system, system 100 may be implemented in some embodiments by a single computing device. For example, both client system 104 and application server 106 may be embodied by an application executed by a processor of a desktop computer, and data source 110 may be embodied by a fixed disk drive within the desktop computer.

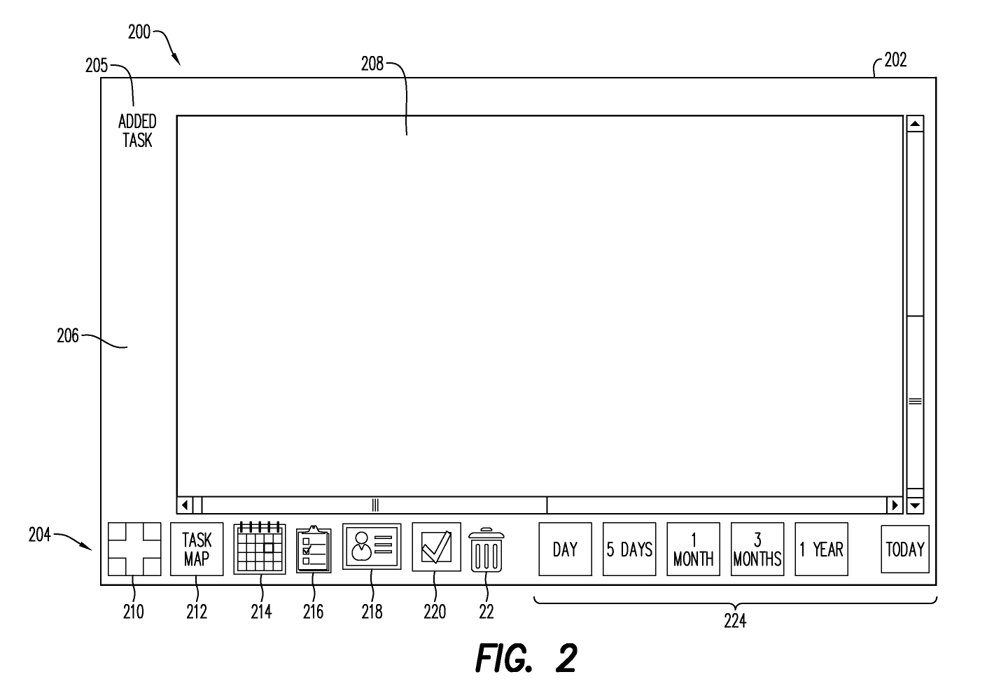

FIG. 2 is an outward view of a task workspace 200 presented on a display 202 according to some embodiments. More specifically, the client system 104 may execute process steps in accordance with the task map app 108 to provide a user with access to the task workspace 200. In one or more embodiments, the task workspace 200 may include a user interface 204 on the display 202, and the user may input information or receive information by the user interface 204. In one or more embodiments, the user interface 204 may include a first portion 206 and a second portion 208, a task input button 210, a task map view button 212, a calendar view button 214, a list view button 216, a contacts button 218, a complete tasks button 220, a delete button 222, and one or more date display buttons 224.

In one or more embodiments, the first portion 206 of the user interface 204 includes an added task space 205 to display tasks that have been added to the task map 200 but have not yet been associated with at least one of a date, time or location. In one or more embodiments, the add task button 210, the task map view button 212, the calendar view button 214, the list view button 216, the contacts button 218, the complete tasks button 220, the delete button 222, and the one or more date display buttons 224 may be included in the first portion 206. In one or more embodiments, the second portion 208 or canvas is the area or space of the user interface 204 where the tasks are organized and managed. In one or more embodiments, images associate with the tasks, as further described below, may be dragged and dropped into the second portion 208 from the added task space 205 in the first portion 206 of the user interface 204 for organizing and managing, as further described below.

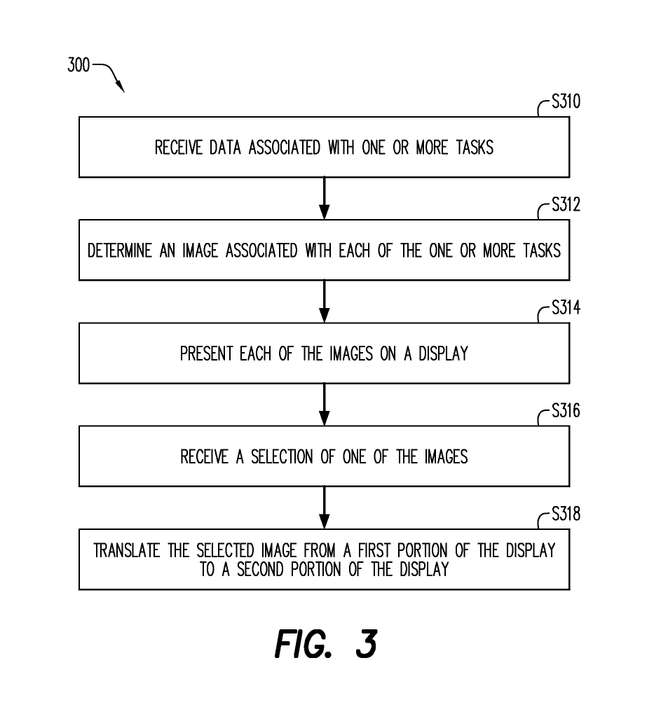

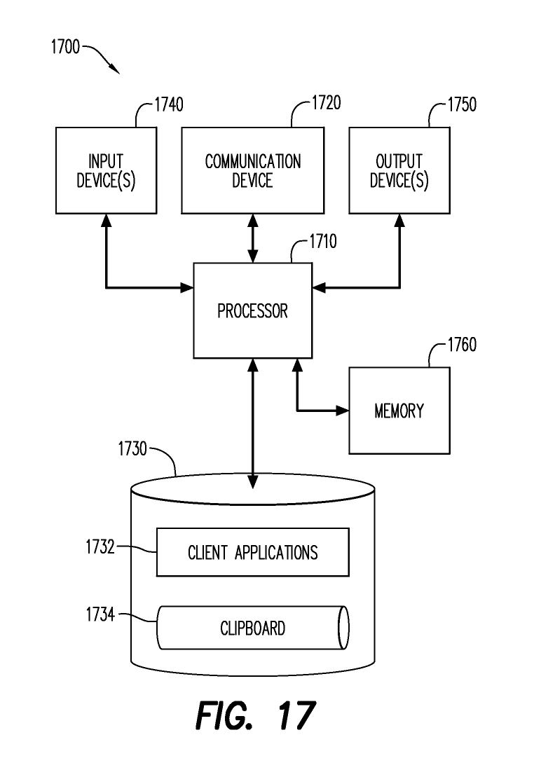

FIG. 3 is a flow diagram of process 300 according to some embodiments. Process 300 may be executed by application server 106 according to some embodiments, e.g., by execution of the task map app 108. In one or more embodiments, the application server 106 may be conditioned to perform the process 300, such that a processor 1710 (FIG. 17) of the server 106 is a special purpose element configured to perform operations not performable by a general purpose computer or device.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S310, data associated with one or more tasks is received. In one or more embodiments, the data associated with the one or more tasks may be data that describes the task, and may be in the form of, for example, a document, an image/photo, a video, an audio file. Data associated with tasks in other suitable forms may be included. For example, data associated with one or more tasks may be a document including a grocery list, or a photo of a doctor's appointment reminder card. In one or more embodiments, the user may create data associated with the task with the user interface 204, as a list, as will be further described below.

In one or more embodiments, the task map app 108 allows importing data associated with tasks into the added task space 205 from external sources, and may allow exporting data associated with tasks to include in other task maps. For example, a mother may want to share or assign a task with her daughter's task map app 108, or other calendar/task application, as will be further described below. In one or more embodiments, the data associated with the task may be exported to any other computing device through email, for example.

Regarding adding data associated with a task from an external source, a user is able to add a document including a list of tasks, a photo of a list of tasks, or other data associated with a task into the added task space 205 from an external source, such as an internet browser (e.g., a website), a camera application on the client system 104 or externally, a photo gallery on the client system 104 or externally, or a document application on the client system 104 or externally, for example. In one or more embodiments, once a user clicks on the add task button 210, the task map app 108 presents him or her with an option to select the data associated with the task from a suitable location. Of note, allowing the creation of tasks from existing images, files and documents supports easy input of tasks. In other embodiments, instead of selecting the data associated with the task from an existing document/photo/file, the user may select the option of creating a new task.

In one or more embodiments, the data associated with the task may be created with a mobile client system 104 (e.g., a mobile computing devices—e.g., smartphones, tablets, etc.). If the data associated with the task is created with a mobile client system 104, the data associated with the task may be automatically pushed to a cloud for storage, for example, and then re-imported to a desktop client system 104, when the user is operating the desktop client system 104. As is well known in the art, cloud computing, often referred to as simply “the cloud,” is the delivery of on-demand computing resources—everything from applications to storage and data centers—over the Internet on a pay-for-use basis.

Then, after the data associated with a task is received at S310, the process 300 continues and in S312, an image 400 associated with each of the one or more tasks is determined (hereinafter referred to as “task image 400”). In one or more embodiments, the task image 400 may be a graphical representation of the task. For example, the task may be represented as a photo, or an image of a document, or any other suitable graphical representation.

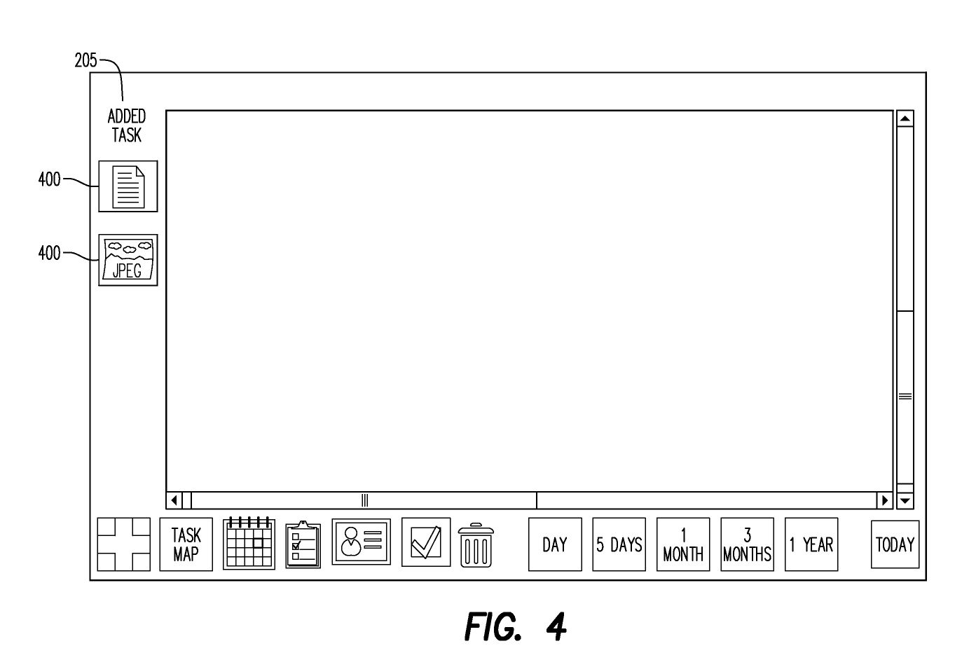

Then in S314, the task image 400 is presented on a display. In one or more embodiments, the task image 400 appears in the added task space 205 of the first portion 206 of the user interface 204 on the display 202. For example, FIG. 4 shows two task images 400, each associated with tasks, added to the added task space 205.

In one or more embodiments, there may be no limit to the number of task images 400 in the task workspace 200. In one or more embodiments, a limit to the number of task images 400 in the task workspace 200 may be a programmable parameter that may be set by a user or an app developer, for example.

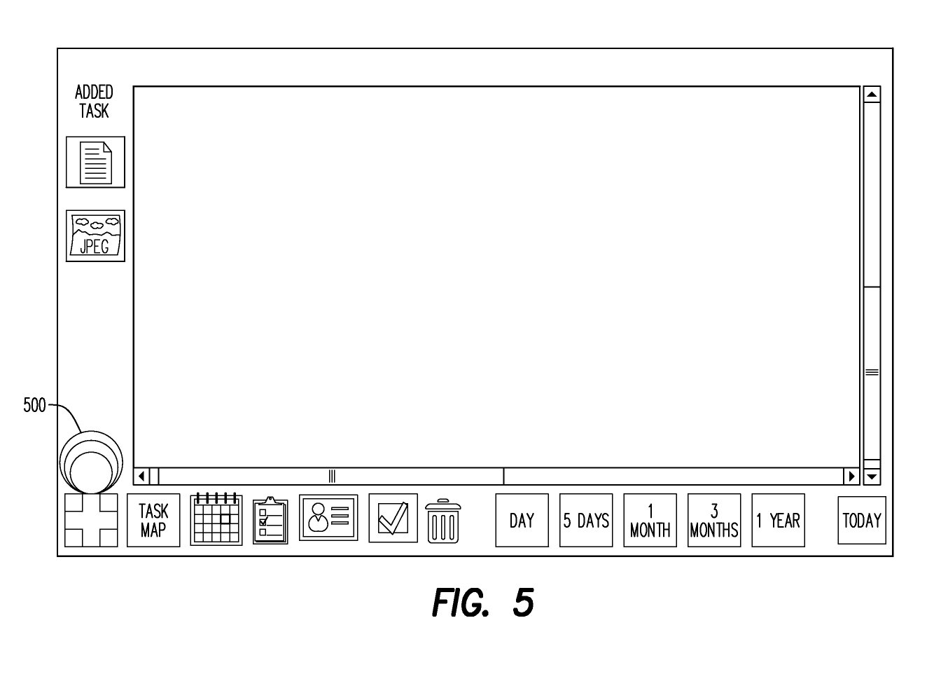

In one or more embodiments, when the user is adding a task image 400, he or she is able to assign the task image 400 a priority level 500 (FIG. 5) by selecting a priority level provided by the task map app 108. In one or more embodiments, the priority level 500 is one of low, medium, and high, and displayed with a commensurately-sized graphic (e.g., a small-sized graphic for low priority, a medium-sized graphic for medium priority, and a large-sized graphic for high priority). In one or more embodiments, the user is able to assign the priority level 500 to the task image 400 after he or she has added the task image 400 to the added task space 205, or after they have moved the task image 400 to the second portion of the display 208. For example, in one or more embodiments, after the user selects (e.g., by clicking on the task image, by highlighting the task image, or by any other suitable selection methods) the task image 400 from either the added task space 205 or the second portion of the display 208, the user may hover a cursor over the add task button 210, resulting in the display of the priority levels 500. The user may then select a desired priority level 500 to associate with the task image 400. In other embodiments, the priority level 500 may be a button included in the first portion 206 of the user interface 204, operated as described above. In other embodiments, the user may see the same user interface for setting priority as a pop-up when an image is dragged into the second portion of the display.

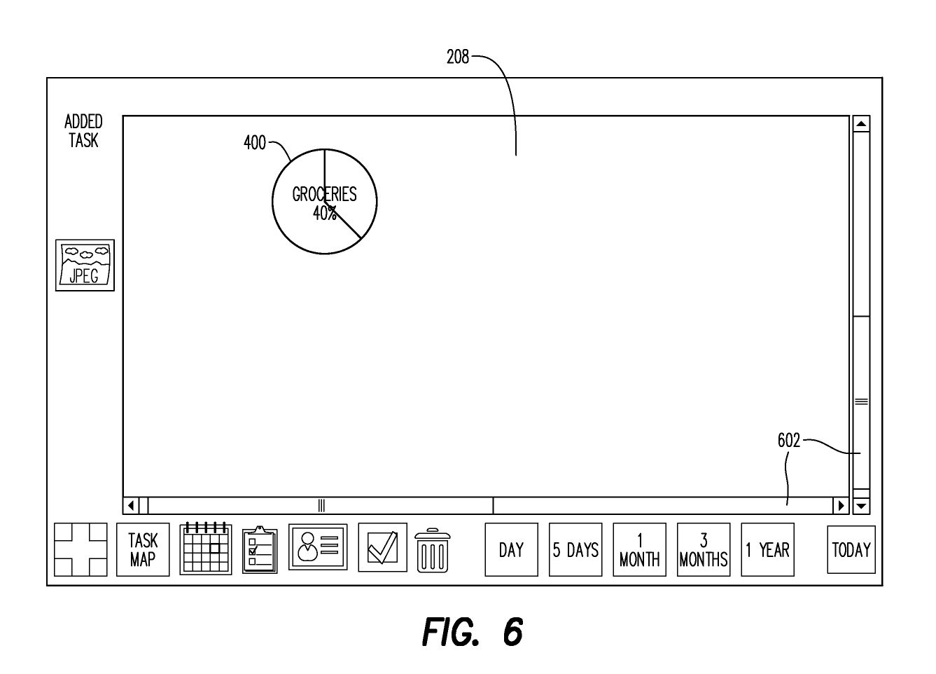

After the task image 400 is presented on the display in the first portion 206 of the user interface 204, selection of one of the task images is received in S316. The selected task image 400 is then moved or translated from the first portion 206 of the user interface to the second portion 208 of the user interface in S318. For example, as shown in FIG. 6, the document task image 400 is now located in the second portion 208 of the user interface. In one or more embodiments, the user may move the task image 400 to a location on the second portion 208 associated with a particular due date, for example. In one or more embodiments, the date provided by the second portion 208 may default to the current date (today). The date display buttons 224 may provide different views of the workspace 200, depending on the date display button 224 selected, and may provide different dates to associate the task image 400 with. In one or more embodiments, the user may select a time associated with the task (e.g., a doctor's appointment at 3 pm). In one or more embodiments, a user may manipulate a scroll bar 602 to change the date displayed and/or to provide views in different time granularities, and/or to view task images 400 associated with the selected date but not present on the screen.

In one or more embodiments, when the task image 400 is moved from the first portion 206 to the second portion 208 of the user interface, the task image 400 may be replaced with a uniform image (e.g., a circle), albeit selectably sized to reflect priority, such that all tasks in the second portion 208 may have a generally uniform appearance to facilitate easy review. In other embodiments, the task image displayed in the first portion 206 may be maintained in the second portion 208.

In one or more embodiments, the task image 400 may be annotated to further describe the task. For example, the task image 400 may include an indication of the portion of the task already completed. As shown in FIG. 6, for example, 40% of the groceries task has been completed. In one or more embodiments, the task map app 108 may update the percentage complete as the task is completed, as indicated by a user. For example, a user may select the complete tasks button 220, or drag the task image 400 to the complete tasks button 220, to indicate a task is completed. In one or more embodiments, when all the subtasks on the task image are checked as complete, the entire task may be automatically set to 100% complete. In one or more embodiments, after a task is complete, a user may remove the task image 400 from the second portion 208, by selecting the delete button 222 or by dragging the task image 400 to the delete button 222.

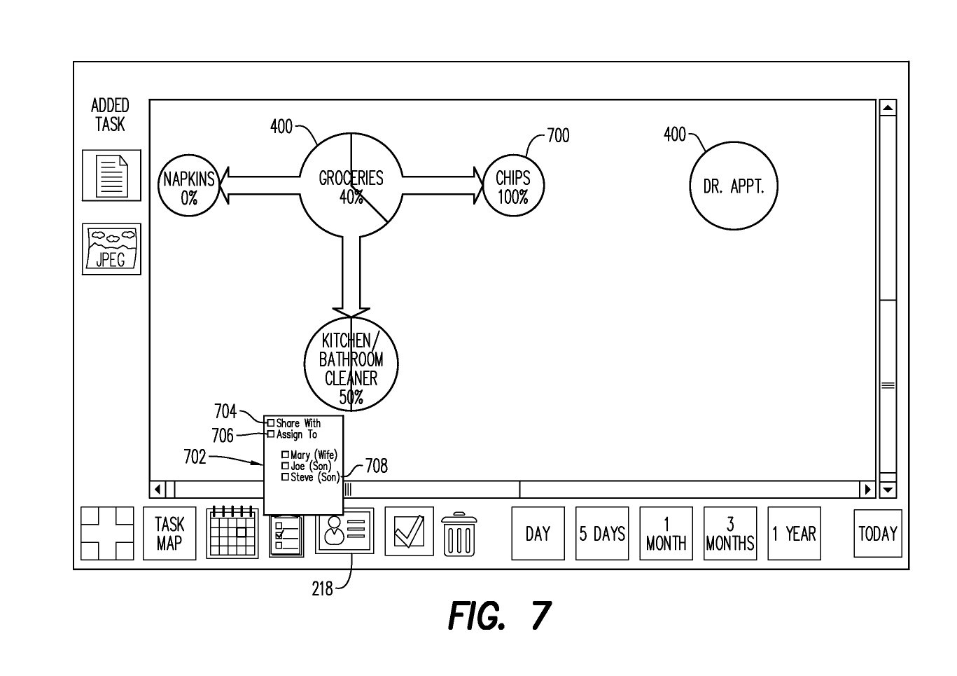

In one or more embodiments, the task may include one or more sub-tasks. In one or more embodiments, the selected task image 400 may be expanded in the second portion 208 to display the sub-task(s) images 700 (FIG. 7) (e.g., image(s) associated with sub-task(s)). The sub-task images 700s may be prioritized and annotated similarly to the primary task images described above, in some embodiments. For example, as shown in FIG. 7, the groceries task image 400 is expanded (by double clicking on the task image 400, for example), to display the napkins, kitchen/bathroom cleaner, chips sub-task images 700. As indicated by the size of the sub-task images 700, the kitchen/bathroom cleaner sub-task is a higher priority than the napkins/chips sub-tasks. As also indicated in FIG. 7, the chips sub-task is complete (100%), while the kitchen/bathroom cleaner sub-task is 50% complete, and the napkins sub-task is not complete (0%).

In one or more embodiments, tasks and subtasks may be combined. For example, a first task may be combined with a second task by selecting, dragging and dropping the first task image over the second task image 400. In one or more embodiments, a sub-task image 700 may be selected and dragged out of its primary task image 400 to form its own task image 400 (and task associated therewith).

In one or more embodiments, the user may share or assign the task by selecting the contacts button 218 or dragging the task image 400 to the contacts button 218. Activation of the contacts button 218 (e.g., via selecting or dragging something thereto) may generate a menu 702 including, for example, an option to share the task 704 or assign the task 706, in one or more embodiments. The menu 702 may also include a list of contacts 708 for assignment or sharing of the task. In one or more embodiments, selection of the contact 708 may launch an email app associated with the client system 104, with pre-filled send-to names/addresses, and the data associated with the task as an attachment or in the body of the email. In one or more embodiments, a user viewing the email may click on the link or an attachment resulting in the launch of the associated application, where the user may view additional information about the task (e.g., itemized grocery list or a location of where the task may be completed). In one or more embodiments the tasks, via images associated therewith, may be added to the contact/recipient's calendar/to-do list etc. in real time. In one or more embodiments, the user may associate the assigned/shared task image with a reminder, which may display on the contact/recipient's calendar/to-do list at an assigned time. For example, a mother may assign chores/homework/piano lessons to her child via the share/assign tasks buttons 704/706, and reminders may be added to the child's electronic device in real-time.

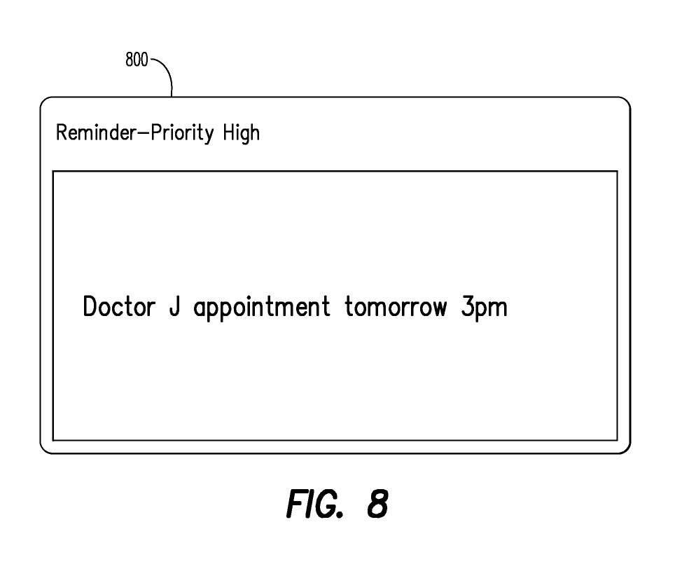

In one or more embodiments, a user may associate a reminder 800 (FIG. 8) with the task image 400. For example, the doctor appointment task image 400 in FIG. 7, has the associated reminder 800 displayed in FIG. 8. In one or more embodiments, the reminder may be at least one of a text box, a text message, an audible sound, a voice memo. In one or more embodiments, the reminder or alert notification may be configurable. The user may have the option of receiving reminders by either a text message or a reminder provided by the mobile device. For example, a user may receive a pop-up reminder, a sound, or a vibration notification on the mobile device.

In one or more embodiments, the task map app 108 may set default values for task images based on past tasks of a same task type (e.g., groceries) or may suggest new tasks based on past tasks. For example, the task map app 108 may generate one or more suggested tasks based on one or more tasks previously associated with a prior task, wherein the prior task is a same type of task as the task associated with the image. For example, for past tasks associated with grocery images 400, the user has included the sub-task images 700 of chips, napkins and kitchen/bathroom cleaner. The task map app 108 determines this association, and when the user creates a new groceries task image 400 including the sub-task images 700 of chips and napkins, the task map app 108 suggests adding a kitchen/bathroom subtask image 700. As another example, the task map app 108 may determine that certain tasks are repeated seasonally or monthly (e.g., shopping for garden supplies or paying bills), and when a user views a future month, or when the task map app 108 determines a possible due date is approaching, the task map app 108 generates a reminder 800 for these suggested tasks. In one or more embodiments, the task map app 108 may determine a possible due date is approaching by comparing a current timeline to a point on a prior timeline when the previously completed tasks were completed.

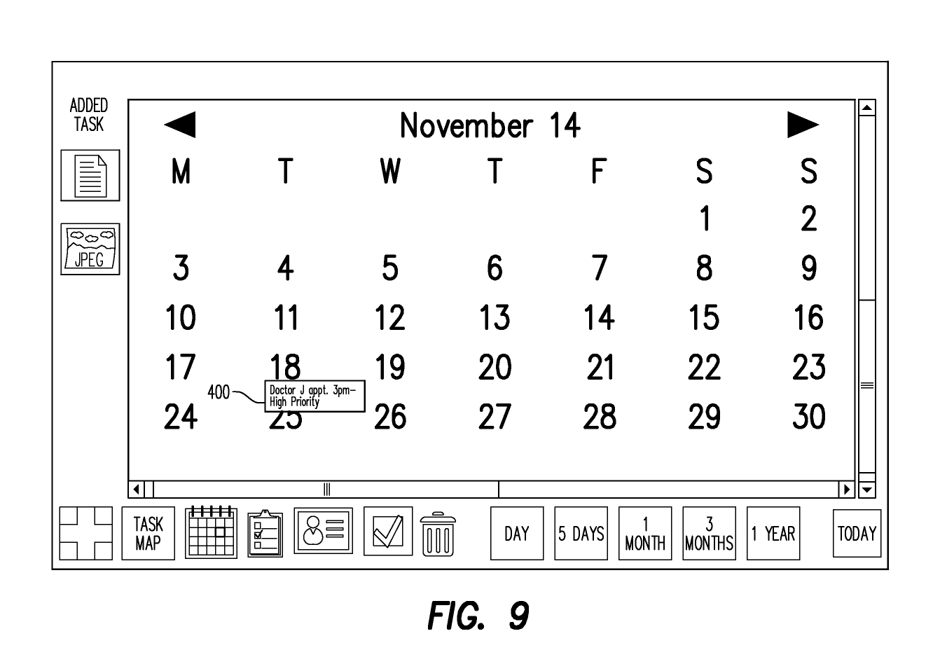

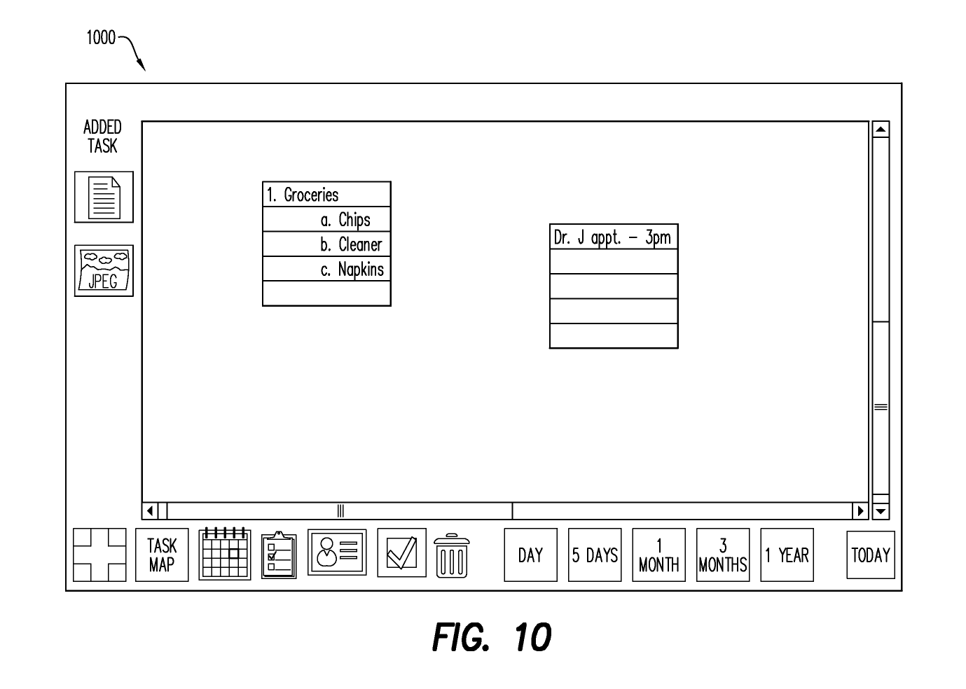

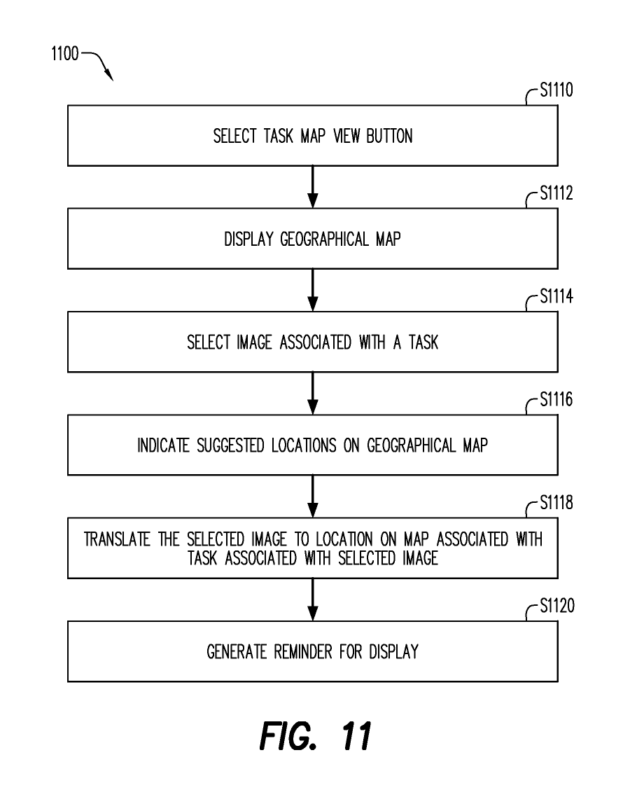

In one or more embodiments, the user interface 204 may default to display the task map canvas, as described above with respect to FIGS. 2 and 4-7. However, in one or more embodiments, the user may select the task map view button 212 to view a geographical map associated with the task (FIG. 11), as further described below, the calendar view button 214 to view the task images in a calendar format 900 (FIG. 9), or the list view button 216 to view each task image in a list format 1000 (FIG. 10).

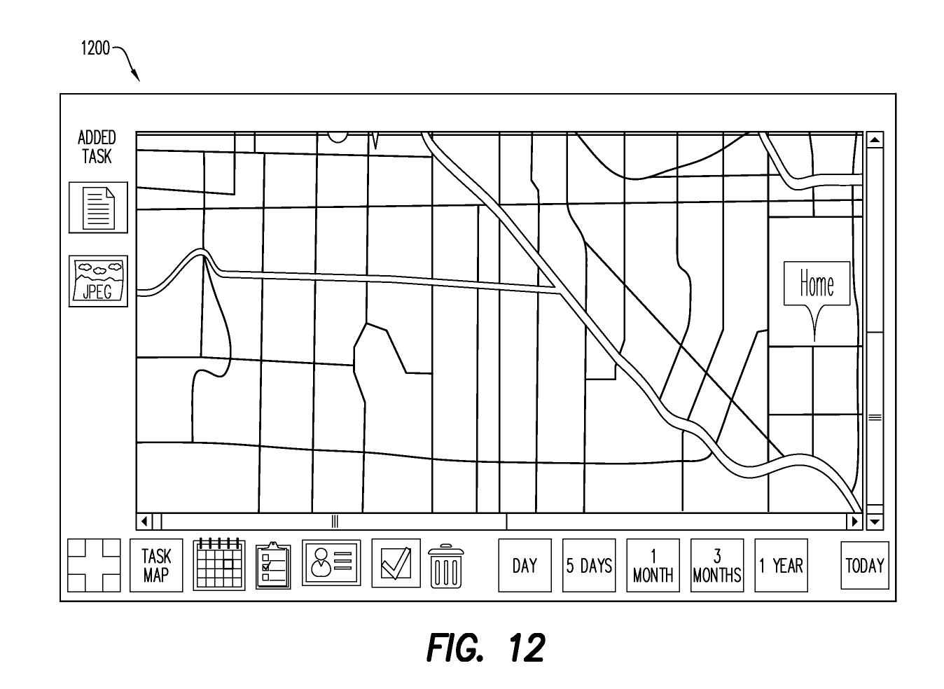

Turning to FIGS. 11-15, a process 1100 and a user interface displaying the second portion 208 including a geographical map 1200 is provided. As described above, the user may associate a geographical location with a given task. Initially at S1110, the task map view button 212 is selected. The second portion 208 of the user interface 204 displays a geographical map 1200 (FIG. 12) in S1112. In one or more embodiments, the user may define the geographical map parameters. For example, the user may set a default map as within a specified circumferential distance of a given location (e.g., 5 miles/km of a home). In one or more embodiments, the user may edit the default map as needed. In one or more embodiments, the user may use the scroll bars 602 to manipulate the portions of the map shown in the second portion 208.

In one or more embodiments, when the task map view button 212 is selected, the task images 400 from both the added tasks 205 first portion 206 and second portion 208 are imported to the task map view 1200 and positioned in the added tasks 205 first portion 206.

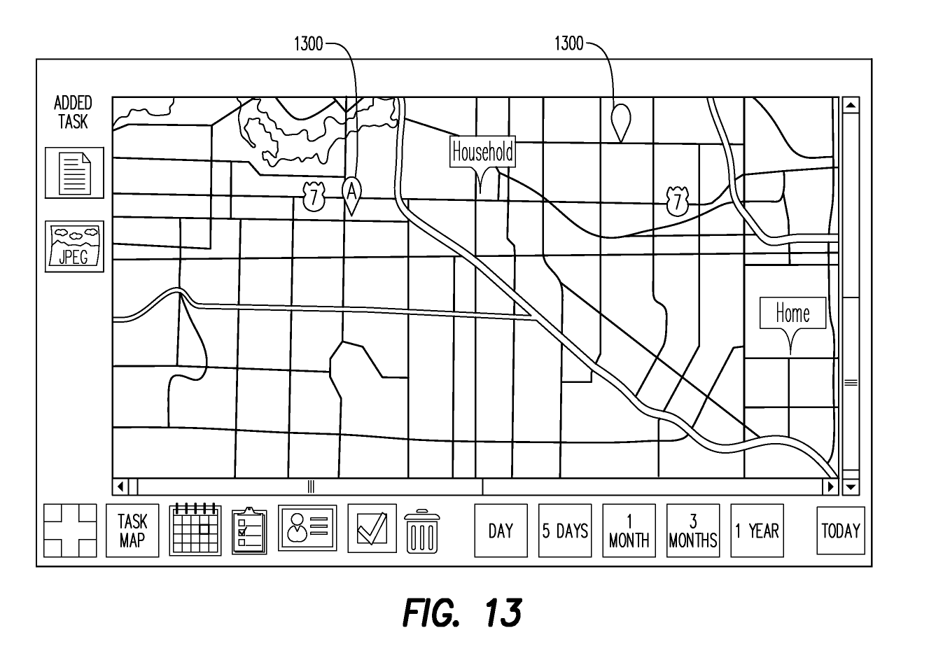

Then in S1114, the user may select the task image 400 from the added tasks 205 portion. In one or more embodiments, in response to selecting the task image 400, one or more locations on the map are indicated in S1116 as suggested locations 1300 (FIG. 13) where the task associated with the selected task image 400 may be performed. The suggested location may be indicated by any suitable indicator. In one or more embodiments, task map app 108 may generate the indication based on input from at least one of one or more reviews, one or more prices, hours of operation and a proximity of the location to a current location of a user, for example. In one or more embodiments, the user may set the distance for suggested locations from a specific point (e.g., only suggest locations within 5 mi/km from home or a current location).

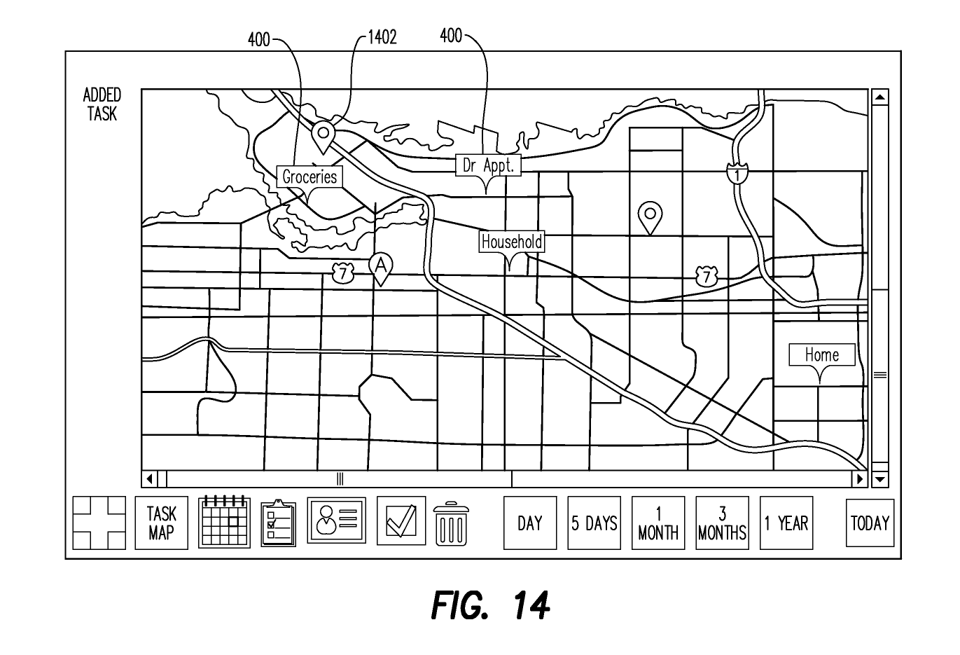

Then, in S1118, the user may move/translate the selected task image 400 to an area on the map geographically related to the task associated with the selected task image 400, as shown in FIG. 14.

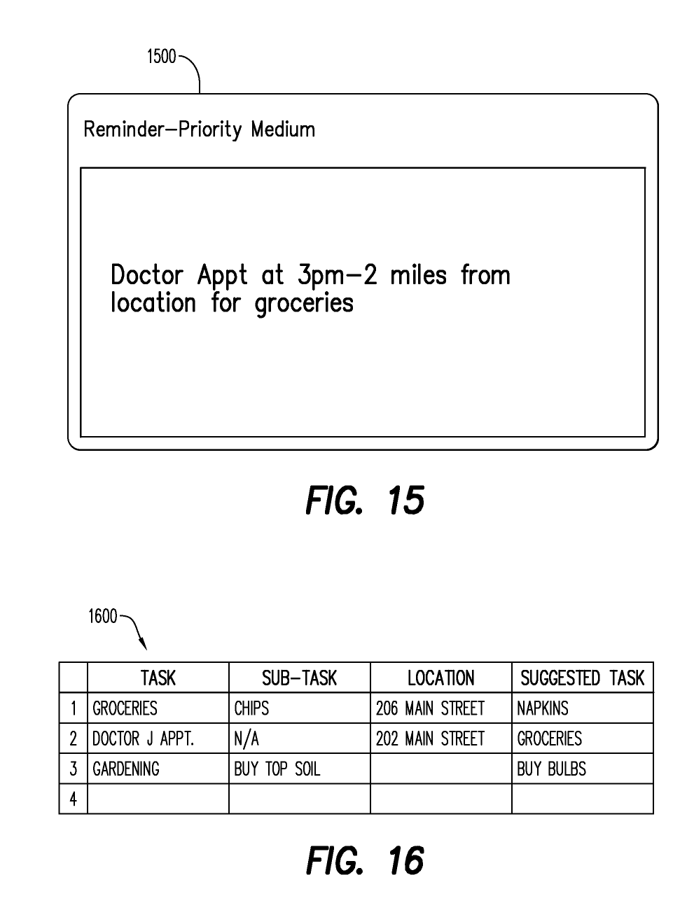

In one or more embodiments, the task map app 108 may provide a reminder 1500 (FIG. 15) to the user of the due date of the task based on a current location 1402 (FIG. 14) of the user, for example, in S1120. For example, a user receives reminders throughout the day while he travels between home and work based on his location. As shown in FIG. 15, the reminder 1500 may indicate that the task associated with the groceries task image 400 may be completed within two miles from the location of the task associated with the doctor's appointment task image 400. As another example, a reminder 1500 may be generated based on past tasks completed in the same or proximate location as the user's current location, or in the same or proximate location as a particular task. In one or more embodiments, reminders in the same pre-determined vicinity on the geographical map may be grouped to reduce clutter on the task map view 1200.

FIG. 16 illustrates table 1600 of task values and associated elements which are stored by a data source (e.g., data source 110). As shown, each value of the task presented in the table 1600 corresponds to one member of each of three elements: sub-task, location and suggested task. For example, the task Groceries corresponds to the “Chips” member of the sub-task element, the “206 Main Street” member of the location element, and “Napkins” of the suggested task element.

FIG. 17 is a block diagram of apparatus 1700 according to some embodiments. Apparatus 1700 may comprise a general- or special-purpose computing apparatus and may execute program code to perform any of the functions described herein. Apparatus 1700 may comprise an implementation of one or more elements of system 100, such as client system 104. Apparatus 1700 may include other unshown elements according to some embodiments.

Apparatus 1700 includes task map processor 1710 operatively coupled to communication device 1720, data storage device 1730, one or more input devices 1740, one or more output devices 1750 and memory 1760. Communication device 1720 may facilitate communication with external devices, such as application server 106. Input device(s) 1740 may comprise, for example, a keyboard, a keypad, a mouse or other pointing device, a microphone, knob or a switch, an infra-red (IR) port, a docking station, and/or a touch screen. Input device(s) 1740 may be used, for example, to manipulate graphical user interfaces and to input information into apparatus 1700. Output device(s) 1750 may comprise, for example, a display (e.g., a display screen) a speaker, and/or a printer.

Data storage device 1730 may comprise any device, including combinations of magnetic storage devices (e.g., magnetic tape, hard disk drives and flash memory), optical storage devices, Read Only Memory (ROM) devices, etc., while memory 1760 may comprise Random Access Memory (RAM).

Applications 1732 of data storage device 1730 may comprise program code executable by task map processor 1710 to provide any of the functions described herein, including but not limited to processes 300 and 1100. Embodiments are not limited to execution of these functions by a single one of applications 1732. Clipboard 1734 may store information in response to an instruction to copy one or more tasks, as described herein. The clipboard may also alternatively be stored in memory 1760. Data storage device 1730 may also store data and other program code for providing additional functionality and/or which are necessary for operation thereof, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of computing devices in communication with one another via any number of other public and/or private networks. Two or more of such computing devices of may be located remote from one another and may communicate with one another via any known manner of network(s) and/or a dedicated connection. Each computing device may comprise any number of hardware and/or software elements suitable to provide the functions described herein as well as any other functions. For example, any computing device used in an implementation of system 100 may include a processor to execute program code such that the computing device operates as described herein.

All systems and processes discussed herein may be embodied in program code stored on one or more computer-readable non-transitory media. Such media non-transitory media may include, for example, a fixed disk, a floppy disk, a CD-ROM, a DVD-ROM, a Flash drive, magnetic tape, and solid state RAM or ROM storage units. Embodiments are therefore not limited to any specific combination of hardware and software.

The embodiments described herein are solely for the purpose of illustration. Those in the art will recognize other embodiments may be practiced with modifications and alterations limited only by the claims.

What is claimed is:

1. A method implemented by a computing system in response to execution of program instruction by a processor of the computing system, the method comprising:
receiving data associated with one or more tasks;
determining an image associated with each of the one or more tasks;
presenting each of the images on a display;
receiving a selection of one of the images;
translating the selected image from a first portion of the display associated with a list of unassigned images associated with tasks to a second portion of the display associated with a timeline.

2. The method according to claim 1, further comprising:
reminding a user of a due date associated with the task based on the position of the image associated with the task in the second portion of the display in relation to a current date.

3. The method according to claim 1, further comprising:
selecting a priority level for each image associated with the task; and
sizing the image associated with the task on the second portion of the display based on the selected priority level, wherein the size increases commensurate with an increase in priority level.

4. The method according to claim 1, further comprising:
determining at least a portion of the task that has been completed; and
updating the image associated with the task to indicate the portion completed.

5. The method according to claim 1, wherein the second portion of the display includes a map.

6. The method according to claim 5, wherein translating the selected image associated with the task from the first portion of the display to the second portion of the display further comprises:
translating the selected image to an area on the map geographically related to the task associated with the selected image.

7. The method according to claim 6, further comprising:
reminding a user of the task based on a current location of the user.

8. The method according to claim 7, wherein reminding the user further comprises:
providing a reminder notification to the user as at least one of a text message, a pop-up message, a sound, or a vibration.

9. The method according to claim 1, further comprising:
indicating one or more locations on a map where the task associated with the selected image may be performed in response to receiving the selection.

10. The method according claim 9, wherein the indication is based on input from at least one of one or more reviews, one or more prices, hours of operation and a proximity of the location to a current location of a user.

11. The method according to claim 9, wherein the indicated locations are based on a user-defined geographical area.

12. The method according to claim 1, further comprising:
generating one or more suggested tasks based on one or more tasks previously associated with a prior task, wherein the prior task is a same type of task as the task associated with the selected image.

13. The method according to claim 1, further comprising:
generating one or more suggested tasks, prior to selecting a task, based on one or more previously completed tasks, wherein the one or more previously completed tasks were associated with a point on a prior timeline corresponding to a current timeline.

14. The method according to claim 1, further comprising:
generating one or more suggested tasks based on one or more previously completed tasks, wherein the previously completed tasks were associated with a geographical location proximate a location associated with the task associated with the selected image.

15. A system comprising:
a memory storing processor-executable process steps; and
a visual task management processor to execute the processor-executable process steps to cause the system to:
receive data associated with one or more tasks;
determine an image associated with each of the one or more tasks;
present each of the images on a display;
receive a selection of one of the images;
translate the selected image from a first portion of a display associated with a list of unassigned images associated with tasks to a second portion of the display associated with a timeline.

16. The system of claim 15 wherein the data associated with the one or more tasks is one of a picture, a document, an auditory file, and a multimedia file.

17. The system of claim 15, wherein the task associated with the selected image includes one or more sub-tasks.

18. The system of claim 15, further comprising a message generated by the visual task manager processor, wherein the message is generated in response to at least one of: a time associated with the task and a location associated with the task.

19. The system of claim 18, wherein the message indicates at least one of the task is due to be performed and the location associated with the task is near a current location of a user.

20. The system of claim 15, further comprising:
a message generated by the visual task manager processor in response to the task associated with the image being a same type as at least one previously completed task.

21. The system of claim 20, wherein the message is generated in response to at least one of a corresponding time and a corresponding location being the same for the previously completed task and the task associated with the image.

22. The system of claim 20, wherein the message includes one or more additional tasks associated with the previously completed task.

23. A non-transitory computer-readable medium storing program code, the program code executable by a computer system to cause to the computer system to:
receive data associated with one or more tasks;
determine an image of each of the one or more tasks;
present each of the images on a display;
receive a selection of one of the images;
translate the selected image from a first portion of a display associated with a list of unassigned images associated with tasks to a second portion of the display associated with a timeline.
